(19) United States
(12) Patent Application Publication
(10) Pub. No.: US 2024/0189837 A1
(43) Pub. Date: Jun. 13, 2024

(54) FAR FIELD LIDAR NOZZLE ASSEMBLY AND BLOWER BRACKET

(71) Applicant: A. RAYMOND ET CIE, Grenoble (FR)

(72) Inventors: Larry Rachow, Lenox, MI (US); James Mell, Chesterfield, MI (US); Mark Beyer, Armada, MI (US); Kevin Bond, Brownstown, MI (US); Kunal Javali, Farmington Hills, MI (US)

(21) Appl. No.: 18/286,443

(22) PCT Filed: Apr. 14, 2022
(86) PCT No.: PCT/IB2022/053550

§ 371 Date: Oct. 11, 2023

Related U.S. Application Data
(60) Provisional application No. 63/175,106, filed on Apr. 15, 2021.

(51) Int. Cl. B05B 1/12; B05B 1/04; B05B 1/06; B05B 1/10; G01S 7/481

(52) U.S. Cl. CPC B05B 1/12; B05B 1/044; B05B 1/10; B05B 1/06; G01S 7/4813

(57) ABSTRACT

A fluid nozzle assembly (10) for cleaning a LIDAR sensor is provided. The nozzle assembly includes a plurality of spray nozzles (14) that are interchangeably received within press-fit openings of a nozzle manifold. At least one of the spray nozzles provides a flat fan spray pattern and another one of the spray nozzles provides a narrow jet, collectively creating a multi-functional spray pattern. In another embodiment, a blower bracket is provided. The blower bracket includes a blower box and a plurality of selectable air nozzle adaptors. The air nozzle adaptors are joined to the blower box along a periphery of the blower box sidewall. The air nozzle adaptors include at least one barbed fitting for attachment to an air hose. The blower bracket provides a variety of configurations for use in specific locations in an overhead or rear tiara.

### CROSS-REFERENCE TO RELATED APPLICATIONS

This application claims the benefit of U.S. Provisional Application 63/175,106, filed Apr. 15, 2021, the disclosure of which is incorporated by reference in its entirety.

### FIELD OF THE INVENTION

The present invention relates to a nozzle assembly and a blower bracket for cleaning a sensor, for example a LIDAR sensor or a camera sensor.

### BACKGROUND OF THE INVENTION

Autonomous vehicles rely on data from LIDAR sensors to navigate the environment around the autonomous vehicle. However, exposure to the elements can affect the output of LIDAR sensors. For example, dirt, snow, ice, and salt can collect on the LIDAR sensor (more precisely, its protective housing) and can affect how the LIDAR sensor perceives the exterior environment. Accordingly, it is generally desired to provide a system to periodically remove foreign matter from the protective housing surrounding the LIDAR sensor.

Existing solutions for back-up cameras include the use of spray nozzles for spraying a liquid, such as windshield washer fluid, onto the camera lens. However, back-up cameras differ from LIDAR sensors in geometry and scale. In particular, LIDAR sensors are typically protected by a curved or cylindrical housing that is several times larger than the lens of a back-up camera. Accordingly, there remains a continued need for a nozzle assembly that is uniquely adapted for preventing the accumulation of foreign matter on LIDAR sensors.

### SUMMARY OF THE INVENTION

In a first aspect of the invention, a fluid nozzle assembly for cleaning a LIDAR sensor is provided. The fluid nozzle assembly includes a plurality of spray nozzles that are received within press-fit openings of a nozzle manifold. The spray nozzles are serially arranged in a generally lengthwise array and are oriented to direct a spray pattern comprising a solid stream (i.e., a narrow jet), a conical spray pattern (e.g., a full cone or a hollow cone), and/or flat fan spray pattern (e.g., a vertical fan or a horizontal fan) toward the curved protective housing of a vehicle LIDAR sensor. Other spray patterns can be used as desired however.

In one embodiment, each of the plurality of spray nozzles is keyed to a respective one of the plurality of press-fit openings, thereby preventing misalignment during installation. The nozzle manifold includes a lower body joined to an upper body, optionally via an ultrasonic weld. The lower body includes a fluid inlet and an internal check valve, and the upper body includes a plurality of pedestals each defining a respective one of the keyed press-fit openings.

In another embodiment, each of the plurality of spray nozzles includes an upper portion, a lower portion, and a disc-shaped flange therebetween. The upper portion includes a spray orifice for discharging the cleaning fluid (e.g., washer fluid) toward the LIDAR sensor. The spray orifice is circular or elongated. For example the spray orifice can include a vertical slit or “cat-eye” opening for discharging a flat fan spray pattern toward the LIDAR sensor. The lower portion of the spray nozzle comprises a male fitting that is received within the press-fit opening in the nozzle manifold.

In a second aspect of the invention, a blower bracket is provided. The blower bracket includes a universal blower box and a plurality of selectable air nozzle adaptors. One of the selectable air nozzle adaptors are joined to the universal blower box along a periphery of the blower box sidewall by snap-fit (snap tabs) or a welded connection (sonic or vibration). The air nozzle adaptors include at least one barbed fitting for attachment to an air hose. For example, an air nozzle adaptor can include only a single barbed fitting, two barbed fittings that are parallel to each other, or two barbed fittings that are angled relative to each other. Because the universal blower box can be coupled to each of the available air nozzle adaptors, the blower bracket provides a variety of configurations for use in specific locations in an overhead or rear tiara.

These and other features and advantages of the present invention will become apparent from the accompanying description of the invention, when viewed in accordance with the accompanying drawings and appended claims.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 includes a perspective view of a nozzle assembly including a nozzle manifold and a plurality of spray nozzles.

FIG. 2 includes a perspective view of the lower body of the nozzle manifold of FIG. 1.

FIG. 3 includes a perspective view of the upper body of the nozzle manifold of FIG. 1.

FIG. 4 includes a perspective view of a spray nozzle for attachment to the nozzle manifold of FIG. 1.

FIG. 5 includes a perspective view of nozzle assembly in accordance with a second embodiment.

FIG. 6 includes a close-up perspective view of a spray nozzle shown in FIG. 5, the spray nozzle providing a vertical fan-like spray pattern.

FIG. 7 is a perspective view of the nozzle assembly of FIG. 5 in combination with a LIDAR sensor.

FIG. 8 are perspective views of a blower bracket assembly including a universal blower box and several air nozzle adaptors.

FIG. 9 is a perspective view of the blower box of FIG. 8 joined to an air nozzle adaptor for directing air to first and second camera nozzle assemblies.

### DETAILED DESCRIPTION OF THE CURRENT EMBODIMENTS

As discussed herein, the current embodiments include a fluid nozzle assembly for cleaning a LIDAR sensor. The fluid nozzle assembly includes a plurality of spray nozzles that are received within press-fit openings of a nozzle manifold. The spray nozzles are arranged in a longitudinal array and are oriented to direct a spray pattern comprising a solid stream (i.e., a narrow jet), a conical spray pattern (e.g., a full cone or a hollow cone), and/or flat fan spray pattern (e.g., a vertical fan or a horizontal fan) toward the curved protective housing of a vehicle LIDAR sensor. The present invention is not limited to LIDAR sensors, however, and the current embodiments can be used in connection with other sensors, for example camera sensors.

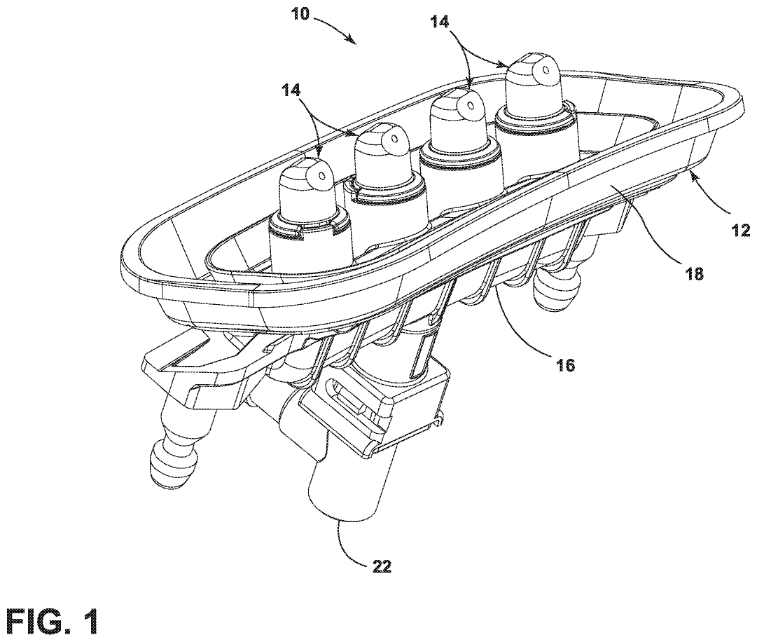

Referring first to FIGS. 1-4, a fluid nozzle assembly for cleaning a LIDAR sensor in accordance with one embodiment is illustrated and generally designated 10. The nozzle assembly 10 includes a nozzle manifold 12 and a plurality of spray nozzles 14. The nozzle manifold 12 includes a lower body 16 and an upper body 18 that cooperate to distribute cleaning fluid from a fluid input 20 to each of the spray nozzles 14. Four spray nozzles 14 are shown in the illustrated embodiment, but greater or fewer number of spray nozzles 14 can be used in other embodiments. Each such feature of the nozzle assembly 10 is discussed below.

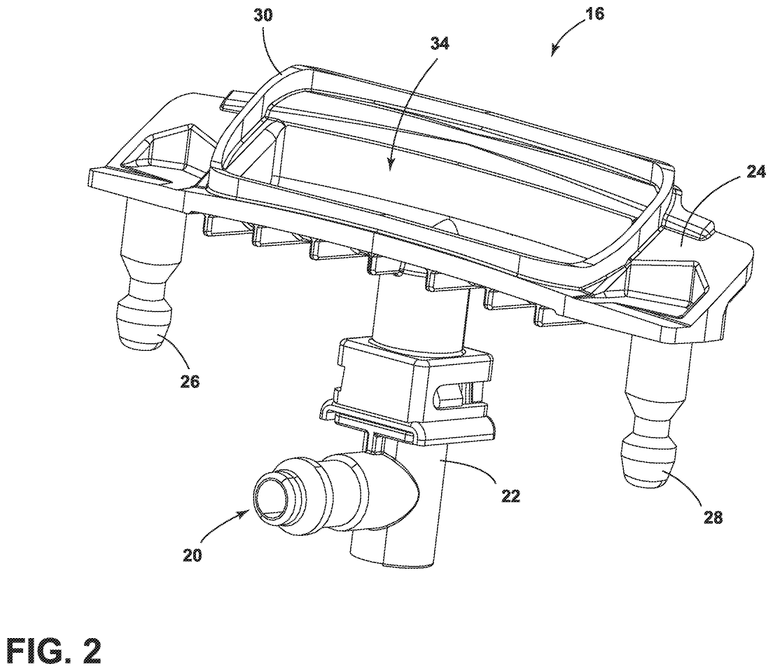

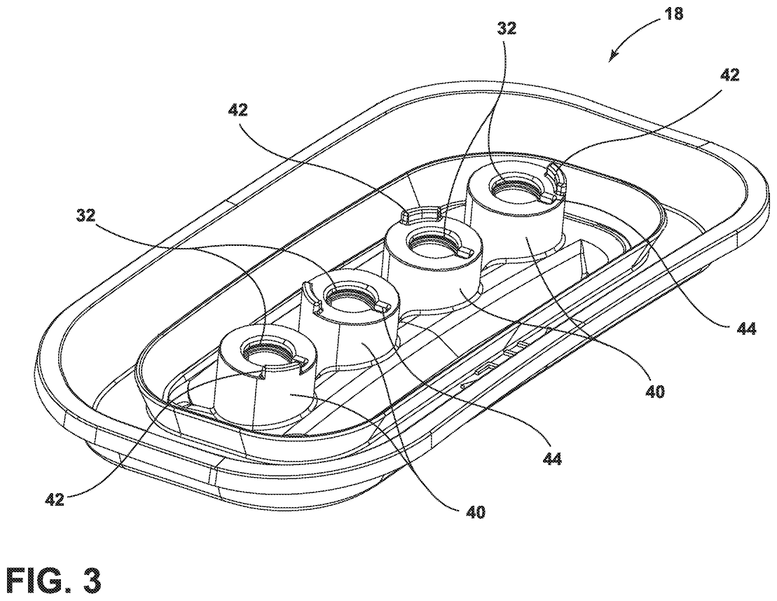

The lower body 16 of the nozzle manifold 12 is illustrated in FIG. 2 and includes the aforementioned fluid inlet 20 for attachment to a pressurized fluid source, for example washer fluid. The lower body 16 also includes a neck portion 22 that is joined to a tray 24, the tray 24 having first and second fittings 26, 28 for securing the nozzle assembly 10 to a vehicle. The neck portion 22 includes an internal check valve, for example a ball check valve, for preventing back flow to the fluid inlet 20. The upper body 18 of the nozzle manifold 12 is shown in FIG. 3 and is joined to the lower body 16 according to any suitable process, for example by creating an ultrasonic weld along an upper periphery 30 of the lower body 16.

As shown in FIG. 3, the upper body 18 of the nozzle manifold 12 includes a plurality of press-fit openings 32 that are arranged in a longitudinal array, wherein the spray nozzles 14 are received in the press-fit openings 32. Four press-fit openings 32 are shown in the illustrated embodiment, but greater or fewer number of press-fit openings 32 can be used in other embodiments. The upper body 18 is joined to the lower body 16, the lower body 16 being coupled to a pressurized fluid source, for example washer fluid. Collectively, the lower body 16 and the upper body 18 define a rectangular fluid chamber 34 immediately beneath each of the spray nozzles 14 for distributing cleaning fluid to each of the spray nozzles 14. As also shown in FIG. 3, each press-fit opening 32 is keyed, such that a spray nozzle 14 can be installed in a single orientation. The upper body 18 includes four pedestals 40, each having a press-fit opening 32. Each pedestal 40 also includes an arcuate ridge 42 and a radial notch 44. Collectively, the arcuate ridge 42 (spanning approximately 30 degrees) and the radial notch 44 prevent misalignment of the spray nozzle 14 during assembly of the fluid nozzle assembly 10.

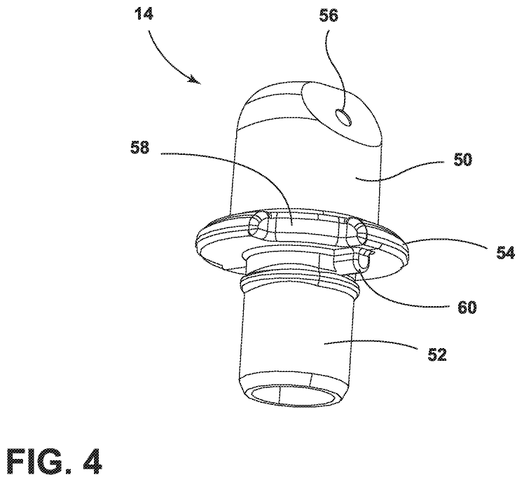

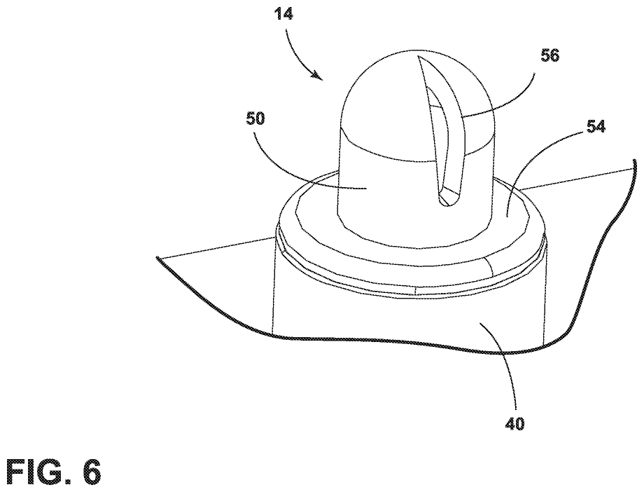

One example of a spray nozzle 14 is shown in FIG. 4. The spray nozzle 14 includes an upper portion 50, a lower portion 52, and a disc-shaped flange 54 therebetween. The upper portion 50 includes a spray orifice 56 for discharging the cleaning fluid (e.g., washer fluid) toward the LIDAR sensor housing. The spray orifice 56 is circular in the illustrated embodiment, but can include other geometries in other embodiments, for example a vertical slit or “cat-eye” opening for discharging a vertical fan spray pattern as shown in FIG. 6. The lower portion 52 comprises a male fitting that is received within the press-fit opening 32 in the upper housing 18 of the nozzle manifold 12. The flange 54 separates the upper portion 50 from the lower portion 52 and includes an arcuate notch 58 and a radial post 60 extending downwardly therefrom. The arcuate notch 58 is shaped to receive the arcuate ridge 42, and the radial post 60 is shaped to be inserted into the radial notch 44 in the pedestal 40. The spray nozzle 14 of FIG. 4 is keyed to the left-most press-fit opening 34 in FIG. 4. In other embodiments, however, each spray nozzle can be installed at any of the corresponding press-fit openings.

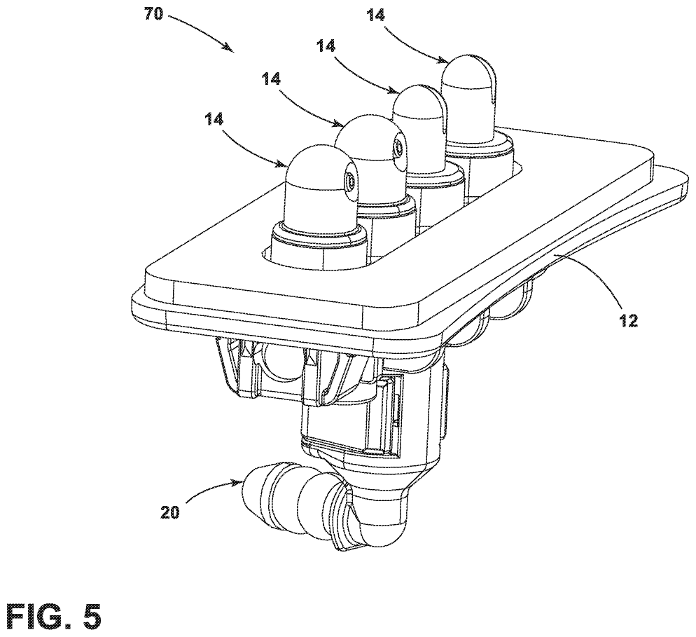

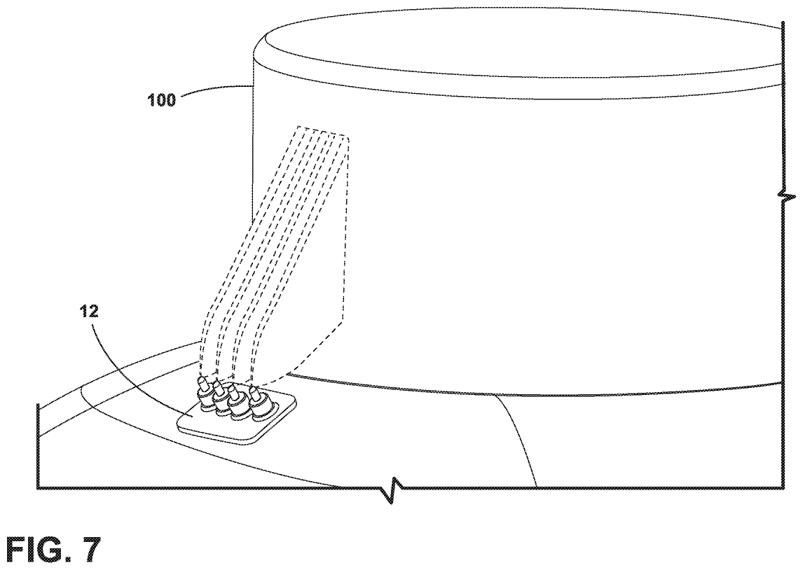

Referring now to FIGS. 5-6, a fluid nozzle assembly in accordance with a second embodiment is illustrated and generally designated 70. The fluid nozzle assembly 70 of FIGS. 5-6 is structurally and functionally similar to the fluid nozzle assembly 10 of FIGS. 1-4, except that the fluid nozzle assembly 70 of FIGS. 5-7 includes a longitudinal array of spray nozzles 14 that provide a narrow-conical spray pattern and a vertical fan-like spray pattern. In particular, first and second spray nozzles 14 include a circular spray orifice for discharging a narrow-conical spray pattern, while third and fourth spray nozzles 14 include a spray orifice in the shape of a vertical slit for discharging a vertical fan-like spray pattern. As optionally shown in FIG. 7, each of the spray nozzles 14 can instead include a spray orifice in the shape of a vertical slit for discharging a vertical fan-like spray pattern onto a LIDAR sensor 100.

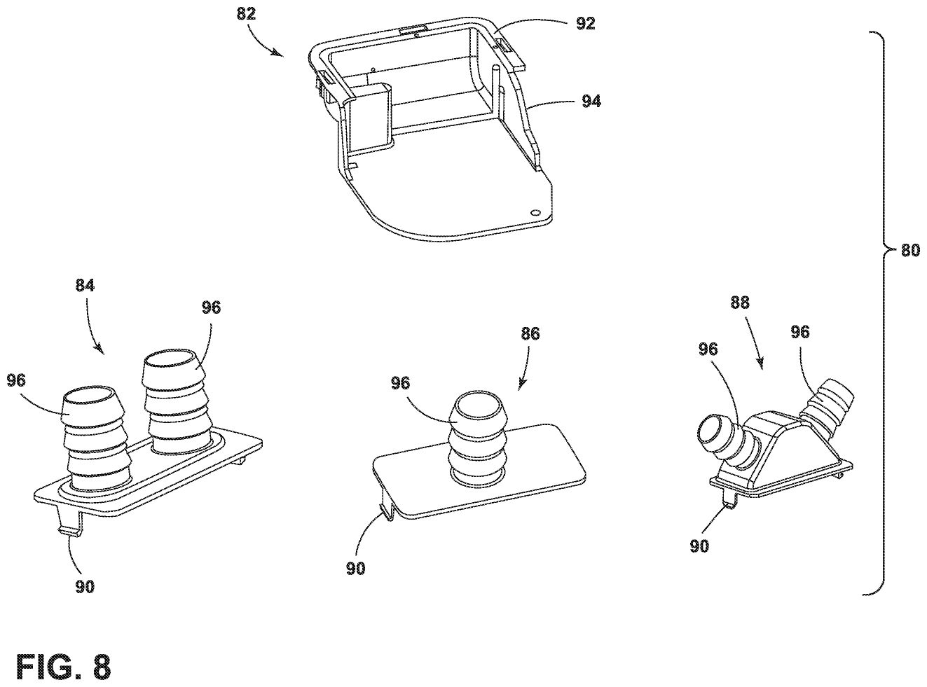

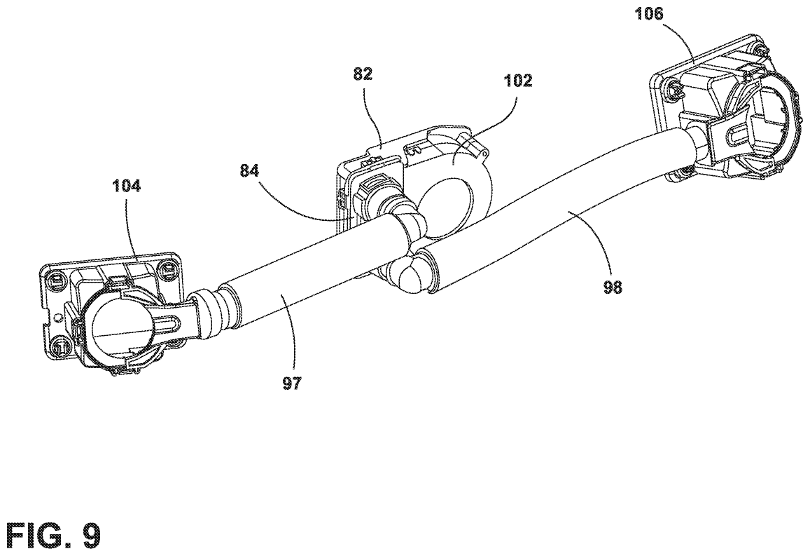

Referring now to FIG. 8, a blower bracket 80 is illustrated for providing compressed air to a camera nozzle assembly of a vehicle, for example an autonomous vehicle. The blower bracket 80 includes a universal blower box 82 and a plurality of selectable air nozzle adaptors 84, 86, 88. One of the selectable air nozzle adaptors 84, 86, 88 is joined to the universal blower box 82 along an upper periphery 92 of the blower box sidewall 94 by snap-fit (snap tabs 90) or a welded connection (sonic or vibration). Each air nozzle adaptor 84, 88, 86 includes at least one barbed fitting 96 for attachment to an air conduit. For example, air nozzle adaptor 84 includes two barbed fittings 96 that are parallel to each other, air nozzle 86 includes a single barbed fitting 96, and air nozzle adaptor 88 includes two barbed fittings 96 that are angled relative to each other. Because the blower box 82 can be coupled to each of the available air nozzle adaptors 84, 86, 88, the blower bracket 80 provides a variety of configurations for use in specific locations in an overhead or rear tiara. As further shown in FIG. 9, by example, the universal blower box 82 is joined to a blower motor 102 for providing first and second camera nozzle assemblies 104, 106 with compressed air. The blower motor 102 is joined to the universal blower box 82 via snap tabs 90 or a welded connection, and the universal blower box 82 is joined to first and second air conduits 97, 98 via the air nozzle adaptor 84 having two barbed fittings 96. The first air conduit 97 is in fluid communication with the first camera nozzle assembly 104, and the second air conduit 98 is in fluid communication with the second camera nozzle assembly 106.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A fluid nozzle assembly for cleaning a LIDAR sensor comprising:
a nozzle manifold including a plurality of press-fit openings on an exposed upper surface thereof, the plurality of press-fit openings being serially arranged in a longitudinal array; and
a plurality of spray nozzles received within the plurality of press-fit openings of the nozzle manifold, wherein each of the plurality of spray nozzles includes a spray orifice for discharging a cleaning fluid toward the LIDAR sensor in a desired spray pattern.

2. The fluid nozzle assembly of claim 1, wherein at least one of the plurality of spray nozzles includes a round spray orifice for producing a solid stream of cleaning fluid.

3. The fluid nozzle assembly of claim 1, wherein at least one of the plurality of spray nozzles includes an elongated spray orifice for producing a flat fan spray pattern.

4. The fluid nozzle assembly of claim 1, wherein the nozzle manifold includes a lower body joined to an upper body.

5. The fluid nozzle assembly of claim 4, wherein the lower body includes a fluid inlet and an internal check valve.

6. The fluid nozzle assembly of claim 4, wherein the upper body includes a plurality of pedestals each defining a respective one of the plurality of press-fit openings.

7. The fluid nozzle assembly of claim 6, wherein each of the plurality of pedestals includes an arcuate ridge and a radial notch adjacent the press-fit opening.

8. The fluid nozzle assembly of claim 4, wherein the upper body is ultrasonically welded to the lower body along an upper periphery of the lower body.

9. The fluid nozzle assembly of claim 1, wherein each of the plurality of spray nozzles includes an upper portion, a lower portion, and a disc-shaped flange therebetween.

10. The fluid nozzle assembly of claim 9, wherein the disc-shaped flange defines an arcuate notch.

11. The fluid nozzle assembly of claim 9, wherein the disc-shaped flange includes a radial post extending downwardly therefrom.

12. The fluid nozzle assembly of claim 1, wherein each of the plurality of spray nozzles is keyed to a respective one of the plurality of press-fit openings.

13. A blower bracket comprising:
a blower box including a sidewall extending upwardly from a base for attachment to a blower for a sensor cleaning system; and
a plurality of air nozzle adaptors that are adapted to be joined to the blower box sidewall along a periphery thereof, each of the plurality of air nozzle adaptors including at least one barbed hose fitting for attachment to an air hose.

14. The blower bracket of claim 13, wherein a first one of the plurality of air nozzle adaptors includes only a single barbed hose fitting.

15. The blower bracket of claim 13, wherein a second one of the plurality of air nozzle adaptors includes two barbed hose fittings that are parallel to each other.

16. The blower bracket of claim 13, wherein a third one of the plurality of air nozzle adaptors includes two barbed hose fittings that are angled with respect to each other.

17. The blower bracket of claim 13, wherein each of the plurality of air nozzle adaptors includes a plurality of snap tabs.

18. The blower bracket of claim 17, wherein an upper periphery of the sidewall of the blower box includes a plurality of openings for respective ones of the plurality of snap tabs.

19. The blower bracket of claim 13, further including a blower motor coupled to the blower box.

20. The blower bracket of claim 13, further including at least one air conduit coupled to one of the plurality of air nozzle adaptors.
